(19) United States
(12) Patent Application Publication
(10) Pub. No.: US 2014/0297920 A1
(43) Pub. Date: Oct. 2, 2014

(54) MULTI-CORE PROCESSOR AND CONTROL METHOD

(71) Applicant: KABUSHIKI KAISHA TOSHIBA, Tokyo (JP)

(72) Inventors: Susumu Takeda, Kawasaki-shi (JP); Shinobu Fujita, Inagi-shi (JP)

(73) Assignee: KABUSHIKI KAISHA TOSHIBA, Tokyo (JP)

(21) Appl. No.: 14/196,438

(22) Filed: Mar. 4, 2014

(30) Foreign Application Priority Data
Mar. 27, 2013 (JP) 2013-065378

(51) Int. Cl. G06F 9/48; G06F 3/06; G06F 9/50

(52) U.S. Cl. CPC G06F 9/4881; G06F 9/50; G06F 3/0604; G06F 3/0655; G06F 3/0673
USPC 711/102; 711/147

(57) ABSTRACT

According to an embodiment, a multi-core processor is capable of executing a plurality of tasks. The multi-core processor includes at least a first core and a second core. The first core and the second core are capable of accessing a shared memory area. The first core includes one or more memory layers in an access path to the shared memory area, the one or more memory layers including a local memory for the first core. The second core includes one or more memory layers in an access path to the shared memory area, the one or more memory layers including a local memory for the second core. The local memory for the first core and the local memory for the second core include memories with different unit cell configurations in at least one identical memory layer.

### CROSS-REFERENCE TO RELATED APPLICATIONS

This application is based upon and claims the benefit of priority from Japanese Patent Application No. 2013-065378, filed Mar. 27, 2013, the entire contents of which are incorporated herein by reference.

### FIELD

Embodiments relate to a multi-core processor and a control method.

### BACKGROUND

In recent years, attention has been paid to non-volatile memories such as MRAM (Magnetic Random Access Memory). Replacing a volatile memory, generally used as a cache memory for a processor, with a non-volatile memory is expected to reduce leakage power and to allow for individual small-scale power shutdowns for inactive processors, thus reducing power consumption.

On the other hand, the non-volatile memory generally involves a longer latency and higher access power than the volatile memory. Because of these characteristics, simple replacement of the volatile memory with the non-volatile memory may disadvantageously lead to degradation of performance or an increase in access power.

### BRIEF DESCRIPTION OF THE DRAWINGS

FIG. 1 is a block diagram showing a multi-core processor according to a first embodiment;

FIG. 2 is a diagram showing an L2 cache for a first core according to a first embodiment;

FIG. 3 is a diagram showing an L2 cache for a second core according to the first embodiment;

FIG. 4 is a diagram showing a processing management unit according to the first embodiment;

FIG. 5 is a diagram showing a core information table according to the first embodiment;

FIG. 6 is a diagram showing a processing information table according to the first embodiment;

FIG. 7 is a diagram showing an example of a technique for statically providing information on processing according to the first embodiment;

FIG. 8 is a diagram showing a processing information table according to a first embodiment;

FIG. 9 is a diagram showing a technique for allocating processing to cores according to the first embodiment;

FIG. 10 is a diagram showing a processing information table according to the first embodiment;

FIG. 11 is a diagram showing a processing information table according to the first embodiment;

FIG. 12 is a diagram showing a processing information table according to the first embodiment;

FIG. 13 is a diagram showing a processing information table according to the first embodiment;

FIG. 14 is a diagram showing a processing information table according to the first embodiment;

FIG. 15 is a diagram showing a processing information table according to the first embodiment;

FIG. 16 is a diagram showing a processing information table according to the first embodiment;

FIG. 17 is a block diagram showing a multi-core processor according to a second embodiment;

FIG. 18 is a block diagram showing a multi-core processor according to a third embodiment;

FIG. 19 is a block diagram showing a multi-core processor according to a fourth embodiment;

FIG. 20 is a diagram showing another example of the L2 cache for the first core according to the first embodiment; and

FIG. 21 is a diagram showing another example of the L2 cache for the second core according to the first embodiment.

### DETAILED DESCRIPTION

According to an embodiment, a multi-core processor is capable of executing a plurality of tasks. The multi-core processor includes at least a first core and a second core. The first core and the second core are capable of accessing a shared memory area. The first core includes one or more memory layers in an access path to the shared memory area, the one or more memory layers including a local memory for the first core. The second core includes one or more memory layers in an access path to the shared memory area, the one or more memory layers including a local memory for the second core. The local memory for the first core and the local memory for the second core include memories with different unit cell configurations in at least one identical memory layer.

In the embodiments described below, examples of a configuration of a multi-core processor are illustrated. Each of the multi-core processors according to the embodiments comprises a plurality of cores provided in one die to execute calculations. The cores can access a shared memory area. Each of the cores comprises at least one memory layer provided in an access path to the shared memory area. The memory layer includes a local memory. In each of the multi-core processors according to the embodiments, at least two local memories in an identical layer comprise memories with different unit cell configurations.

The “core” refers a calculation device that executes a calculation for each instruction. The “instruction” represents a function that defines a type of calculation that can be executed by the core. An “instruction set” represents a group of instructions that can be carried out by the core.

The “shared memory area” is a memory area shared by a plurality of cores and in which different cores can access the same data. For example, a main memory device is a shared memory area.

The “memory layer” refers to a group of memories which can store data from the shared memory area and which are accessed by the core at different speeds. For example, a group of memories comprising a register, an L1 cache, and an L2 cache is a memory layer.

The “memories in the same layer” represents memories at an equal logical distance from the core. For example, in a configuration comprising two cores, a first core and a second core, each of the cores comprising an L1 cache and an L2 cache, the L1 cache for the first core and the L1 cache for the second core are memories in the same layer. The L2 cache for the first core and the L2 cache for the second core are also memories in the same layer. The L1 cache for the first core and the L2 cache for the second core are not memories in the same layer. The L1 cache, the L2 cache, and an L3 cache may be physically different memories or memory areas resulting from logical division of a physical memory.

The “local memory” represents a memory area that a certain core can access faster than the other cores.

The “memories with different unit cell configurations” represents memories some or all of whose memory cells are different from one another in a physical principle for storage of information or in a transistor level circuit, For example, a volatile memory and a non-volatile memory are memories with different unit cell configurations. As a specific example, SRAM and MRAM are a volatile memory and a non-volatile memory, respectively, that is, memories with different unit cell configurations. MRAM and ReRAM (Resistance Random-Access Memory) are both non-volatile memories but have different unit cell configurations. MRAM and PRAM (Phase change RAN) are also both non-volatile memories but have different unit cell configurations. Furthermore, 6-transistor SRAM and 8-transistor SRAM are both SRAMs but have different unit cell configurations. On the other hand, the following are not memories with different unit cell configurations: two memories which are the same in the physical principle for the storage of information and in the transistor level circuit and which are different from each other in capacity, latency, or the like. Similarly, memories different from one another only at a physical level are not memories with different unit cell configurations. For example, 6-transistor SRAMs different from one another only in a manufacturing process utilized are not memories with different unit cell configurations.

### First Embodiment

[Memory Configuration]

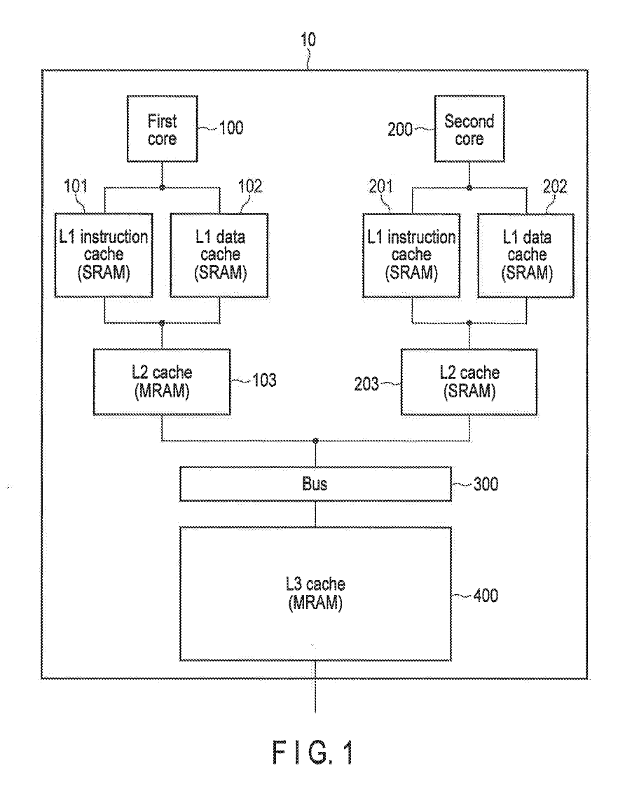

As shown in FIG. 1, a multi-core processor according to a first embodiment comprises a first core 100 and a second core 200 in a die 10. Instruction sets provided in the first core 100 and the second core 200 may be the same or different from each other. The first core 100 comprises an L1 instruction cache 101, an L1 data cache 102, and an L2 cache 103 as local memories. The second core 200 comprises an L1 instruction cache 201, an L1 data cache 202, and an L2 cache 203 as local memories. Furthermore, the multi-core processor according to the present embodiment comprises an L3 cache 400 shared by the first core 100 and the second core 200. The L2 cache 103 for the first core 100 is connected to the L3 cache 400 via a bus 300. The L2 ache 203 for the second core 200 is connected to the L3 cache 400 via the bus 300. In an example illustrated in the present embodiment, the L1 cache is divided into the L1 instruction cache that stores instructions and the L1 data cache that stores data. However, one L1 cache may store both data and instructions.

The first core 100 and the second core 200 both utilize SRAMs that are volatile memories as the L1 instruction cache (101, 201) and the L1 data cache (201, 202) and utilize MRAM that is a non-volatile memory as the shared L3 cache 400.

Furthermore, the first core 100 utilizes MRAM as the L2 cache 103, and the second core 200 utilizes SRAM as the L2 cache 203. For the first path, a path from the first core 100 to the L3 cache 400 is SRAM (L1 caches 101 and 102)→MRAM (L2 cache 103)→MRAM (L3 cache 400). In contrast, for the second core 200, a path from the second core 200 to the L3 cache 400 is SRAM (L1 caches 201 and 202)→SRAM (L2 cache 203)→MRAM (L3 cache 400). Thus, the first core 100 and the second core 200 have different memory cell configuration.

In the first embodiment, it is assumed that MRAM and SRAM are as an example of memories with different unit cell configurations. However, such different memories are not limited to a combination of MRAM and SRAM. Any combination of memories may be used as long as the memories have different unit cell configurations. The memories and configurations in the layers other than the L2 cache are not limited to the first embodiment. For example, the L1 cache may be of an MRAM instead of an SRAM, and the L3 cache may be of an SRAM instead of an MRAM. Furthermore, a position where the bus is provided is not limited to the position in FIG. 1. For example, the L3 may be omitted, and the bus may be connected directly to a main memory. The bus may he present between the L1 cache and the L2 cache or the bus 300 in FIG. 1 may be omitted.

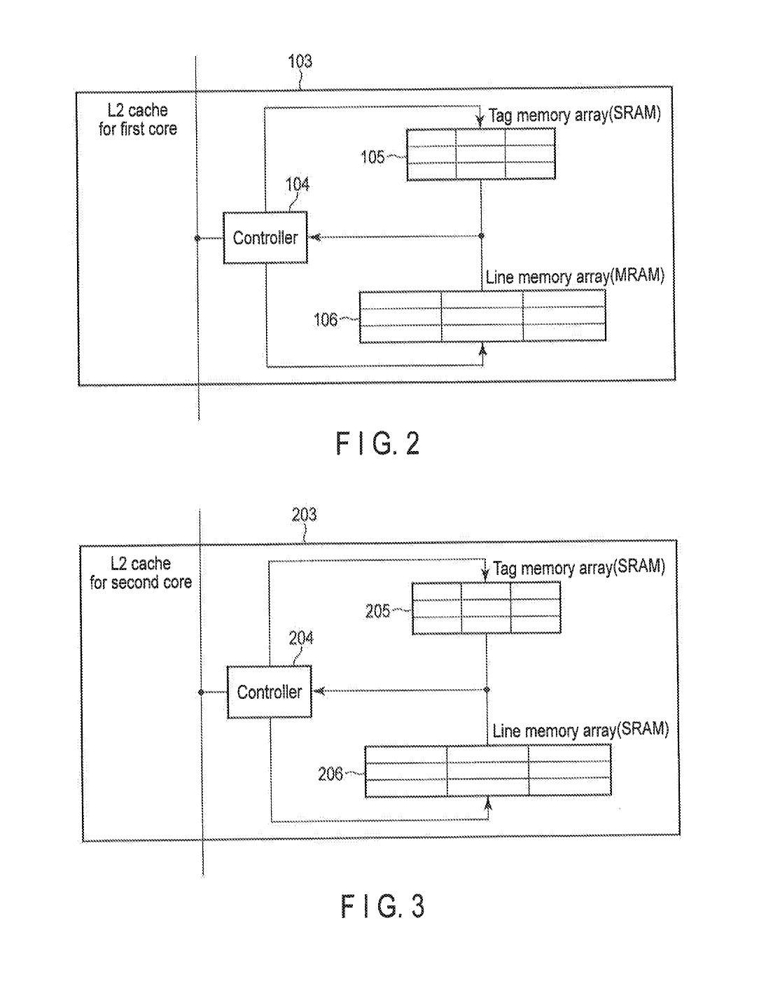

For simplification of description, FIG. 1 shows that the L2 cache 103 for the first core 100 is wholly configured using MRAM and that the L2 cache 203 for the second core 200 is wholly configured using SRAM. However, the caches need not necessarily be configured in such a manner. In other words, “memories with different unit cell configurations” may be used as parts of the memories providing the L2 caches for the first core 100 and the second core 200. By way of example, FIG. 2 and FIG. 3 show detailed configurations of the L2 caches for the first core 100 and the second core 200, respectively. In general, a cache memory comprises two memory arrays, a tag memory array and a line memory array. The tag memory array is a memory that stores address information on data held in the cache memory. The line memory array is a memory that stores the data held in the cache memory. A controller is an information processing device that manages storage of data in the two memory arrays, referencing of data, erasure of data from the two memory arrays, and the like.

As shown in FIG. 2, in the L2 cache 103 for the first core 100, SRAM is utilized as a tag memory array 105, and MRAM is utilized as a line memory array 106. Furthermore, in the L2 cache 203 for the second core 200, SRAM is utilized as a tag memory array 205, and SRAM is also utilized as a line memory array 206, as shown in FIG. 3. The L2 caches 103 and 203 for the first core 100 and the second core 200 as described above correspond to a configuration that uses “memories with different unit cell configurations”.

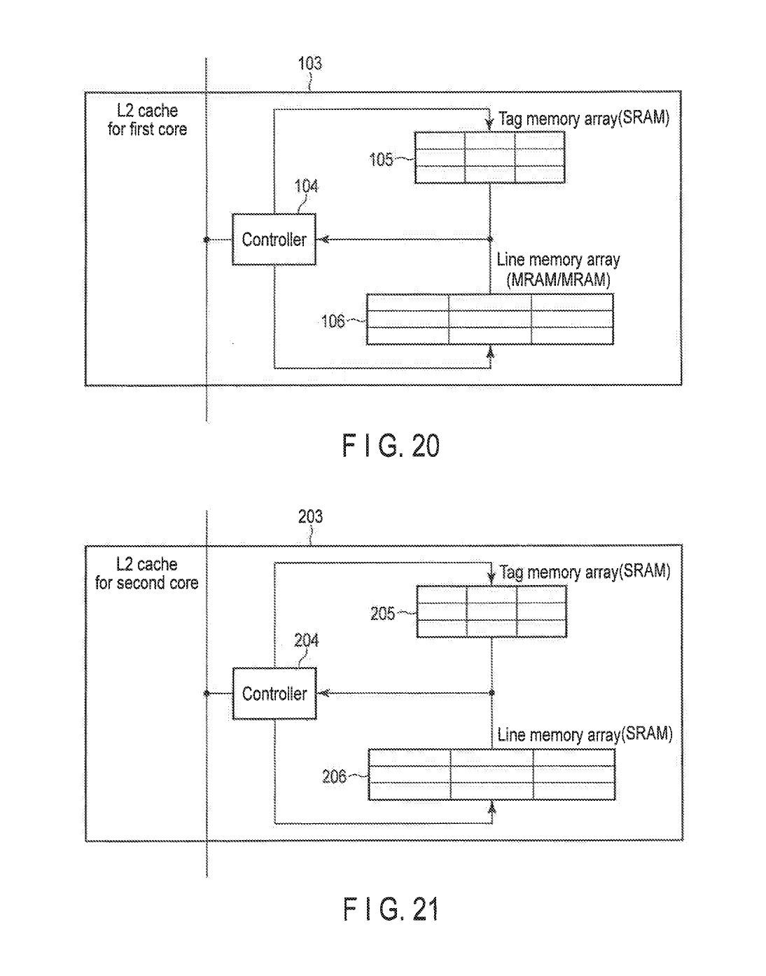

As shown in FIG. 20, in the L2 cache 103 for the first core 100, SRAM is utilized as the tag memory array 105, and MRAM is utilized as a part of the line memory array 106, with SRAM utilized as the remaining part of the line memory array 106. Furthermore, in the L2 cache 203 for the second core 200, SRAM is utilized as the tag memory array 205, and SRAM is also utilized as the line memory array 206, as shown in FIG. 21. The L2 caches 103 and 203 for the first core 100 and the second core 200 as described above correspond to a configuration that uses “memories with different unit cell configurations”.

Of course, MRAM may be utilized as the tag memory line 105 and the line memory array 106 in the L2 cache 103 for the first core 100. SRAM may be utilized as the tag memory line 205 and the line memory array 206 in the L2 cache 203 for the second core 200.

[Hardware Control Scheme]

A hardware control scheme for the multi-core processor shown in FIG. 1 is not limited to a particular control scheme in terms of coherency. For example, either hardware or software may be used to maintain coherency for the local memories for the first core 100 and the second core 200. To maintain coherency, for example, either a MESI (Modified Exclusive Shared Invalid) protocol or a MOESI (Modified Owner Exclusive Shared Invalid) protocol may be utilized. For example, a data placement scheme used between a higher cache and a lower cache may be either write-through or write-back. For example, a scheme used to fill data may be either write allocation or non-write allocation. Furthermore, coherency need not necessarily be maintained for the local memories for the first core 100 and the second core 200.

A control scheme used to reference data in each of the modules providing the multi-core processor shown in FIG. 1 is not limited to a particular control scheme. This will be described with reference to by way of example, the L2 cache 103 for the first core 100 shown in FIG. 2. Options for the control scheme used to reference data are, for example, a sequential scheme and a parallel scheme. The sequential scheme involves accessing the tag memory array 105 to check whether desired data is stored in the line memory array 106 and then accessing the line memory array 106. The parallel scheme involves accessing the tag memory array 105 and the line memory array 105 at the same time and utilizing the result of the access to the line memory array 106 only when the result of the access to the tag memory array 105 indicates that desired data is stored in the line memory array 106. Any such scheme may be utilized. The following are optional: the control schemes for the first core 100 and the second core 200, the control schemes for the L1 instruction cache, the L1 data cache, the L2 cache, and the L3 cache, and a bus control scheme in the above-described example.

[Software Control Scheme]

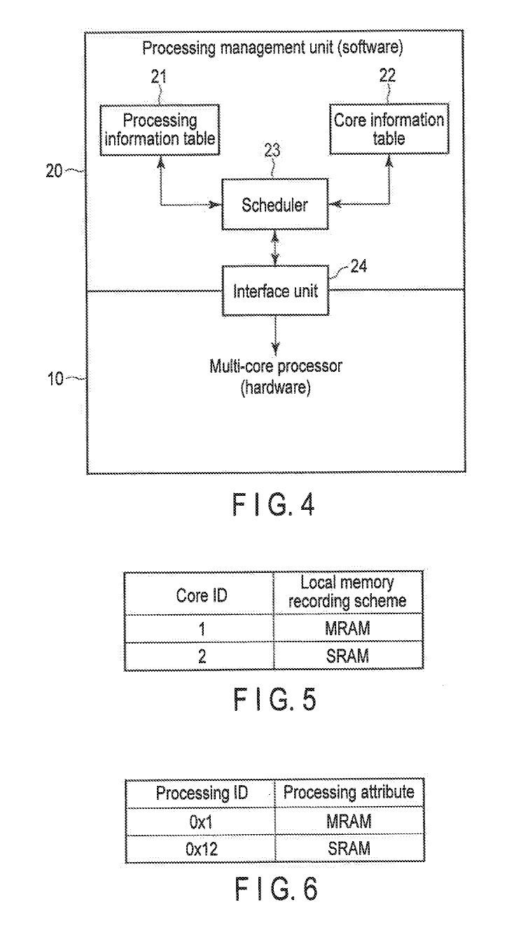

A processing management unit 20 shown in FIG. 4 manages information on processing and allocates processing to the first core 100 and the second core 200, shown in FIG. 1. The “processing” represents an instruction sequence comprising two or more instructions, and is, for example, a process, a thread, or basic blocks. The processing management unit 20 comprises a scheduler 23, a processing information table 21, a core information table 22, and an interface unit 24. The processing management unit 20 is mostly implemented using software, but a part or all of the processing management unit 20 may be implemented using hardware.

The processing information table 21 is a table in which information on each type of processing is recorded. The core information table 22 is a table in which information on each core is recorded. The interface unit 24 has an input/output function to exchange information with hardware (multi-core processor 10). The scheduler 23 allocates processing to hardware (any one of the cores of the multi-core processor 10) via the interface unit 24 based on information in the processing information table 21 and the core information table 22. Furthermore, the scheduler 23 receives information from the hardware via the interface unit 24 to update the contents of the processing information table 21 and the core information table 22. The processing management unit 20 may be implemented using software. A program for the processing management unit 20 may be executed in the first core 100 or second core 200 in FIG. 1 or a calculation device other than the first core 100 and the second core 200. Alternatively, the processing management unit 20 may be implemented using hardware.

FIG. 5 shows an example of the core information table 22 applied to the configuration in FIG. 1. Information that identifies cores is recorded in a core ID item. According to the first embodiment, the first core 100 is identified as ID1, and the second core 200 is identified as ID2. Furthermore, the type of the local memory for the core is recorded in a local memory recording scheme item. For the first core 100, MRAM is used as the local memory, and thus, information that can identify MRAM (in the present example, character string “MRAM”) is recorded. For the second core 200, SRAM is used as the local memory, and thus, information that can identify SRAM (in the present example, character string “SRAM”) is recorded.

According to the first embodiment, the type of the local memory for the core is expressed as a character string, which is recorded. However, the type need not necessarily be expressed as a character string and any information may be used which enables the scheduler 23 to identity the characteristics of the core. For example, a specification may be pre-provided such that MRAM corresponds to a value “1” and that SRAM corresponds to a value “2”. In the core information table 22, “1” may be recorded as the local memory recording scheme for the core ID1, and “2” may be recorded as the local memory recording scheme for the core ID2. In the example illustrated in FIG. 5, it is assumed that only the local memory recording scheme is recorded in the core information table 22 as information. However, another type of information may be recorded. For example, the calculation capability of the core such as the operating frequency of the core may be recorded.

Several techniques are possible for allocating processing to the cores (scheduling processing for the cores). In the first embodiment, examples of the following will be described: a technique (1) for static scheduling based on pre-execution provision information and two techniques ((2) and (3)) for dynamic scheduling in view of execution efficiency, and a technique (4) that is a combination of the three techniques.

The scheduling technique is not limited to the above-described techniques. For example, the scheduling may be carried out in view of power consumption, the temperature of the processor, or a combination of performance, power consumption, temperature, and the like.

In the multi-core processor in FIG. 1, efficiently allocating processing in view of performance is difficult as described below.

In general, MRAM involves a longer latency (lower speed) but a larger storage capacity per unit area (hereinafter simply referred to as a “capacity”) than SRAM. On the other hand, SRAM involves a shorter latency (higher speed) but a smaller storage capacity per unit area than SRAM. In other words, when the L2 cache 103 for the first core 100 and the L2 cache 203 for the second core 200 are arranged on the die 10 so as to have the same area, the two types of memories are in a trade-off relation in terms of latency and capacity. Thus, when a certain type of processing is carried out, which core (first core 100 or second core 200) with the corresponding memory has an increased execution efficiency depends on the characteristics of the processing executed. Ideally, the first core 100 is desirably allocated with a type of processing whose execution efficiency is affected by capacity (cache miss) more significantly than latency, and the second core 200 is desirably allocated with a type of processing whose execution efficiency is affected by latency more significantly than capacity.

(1) Allocation Based on Pre-Execution Provision Information

A technique will be described in which, before a program is executed, core allocation information for processing is specified and in which the scheduler 23 allocates processing to the cores in accordance with a processing attribute based on the core allocation information. FIG. 6 shows an example of the processing information table 21 generated by the processing management unit 20 based on the pre-execution provision information on processing. A processing ID is a unique identifier that identifies processing. The processing attribute is information on the core to which processing is to be allocated. The processing management unit 20 reads the pre-execution provision information associated with processing, records the character string MRAM as the processing attribute of processing with a processing ID 0x1, and records the character string SRAM as the processing attribute of processing with a processing ID 0x12. The processing attribute “MRAM” indicates that the target processing is to be allocated to the core with MRAM as a local memory. The processing attribute “SRAM” indicates that the target processing is to be allocated to the core with SRAM as a local memory.

In the first embodiment, information on the allocation target core is expressed as a character string. However, the information may be in any form as long as the information allows the scheduler 23 to determine the core to be allocated. For example, a specification is pre-provided such that the processing attribute to be allocated to the core with MRAM as a local memory corresponds to the value “1” and that the processing attribute to be allocated to the core with SRAM as a local memory corresponds to the value “2”. The value “1” may be recorded as the processing attribute of the processing ID x1, and the value “2” may be recorded as the processing attribute of the processing ID x12. Alternatively, instead of these values, core IDs may be recorded.

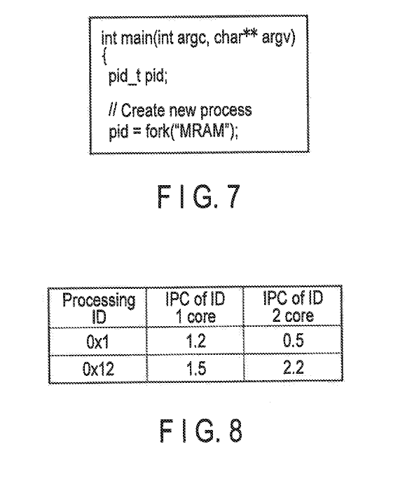

Any technique for specifying pre-execution provision information on processing may be used as long as the processing management unit 20 can identify information indicating to which core processing is to be allocated. For example, as a possible technique, a programmer provides information while describing a program, and compiles the program to embed the pre-execution provision information in binary data. Furthermore, during the last execution, information on the core to be allocated may be recorded in the processing information table 21. A possible technique for providing information while describing a program involves specifying, as an argument, the processing attribute “MRAM”, indicating that the processing is to be allocated to the core with MRAM as a local memory, for example, as shown in FIG. 7, when a new process is generated. In this case, the processing management unit 20 may load binary data resulting from compiling of the program, read an argument of a fork ( ) function, and record the processing ID of the processing (process) and the processing attribute “MRAM”, which are generated by fork ( ). Many variations are possible for a technique for specifying the processing attribute and a means for carrying out the specification. For the technique for specification, for example, when the program is initiated, the information may be provided by a console in an OS or the like. Furthermore, for the means for carrying out the specification, a tool such as a complier which has a program static-analysis function may automatically specify the processing attribute.

The scheduler 23 references the processing information table 21 to obtain information indicating the type of the memory (processing attribute) for the core to which the target processing is to be allocated. For example, when allocating the processing ID 0x1, the scheduler 23 determines that the processing is to be allocated to the core with MRAM as a local memory based on the contents of the processing information table 21 in FIG. 6. Then, to obtain information on the core with MRAM as a local memory, the scheduler 23 references the core information table 22 in FIG. 5. Thus, the scheduler 23 determines that the core with the core ID1 comprises MRAM as a local memory. Finally, the scheduler 23 allocates the processing with the processing ID 0x1 to the core with the core ID1 (the first core 100 in FIG. 1) via the interface unit 24.

The scheduler 23 need not necessarily allocate the processing to the cores strictly in accordance with the processing attribute. For example, in the core to which the processing is to be allocated, another processing may be in execution. In such a case, the processing may be allocated to a core not specified in the processing attribute item in view of load balancing.

(2) Processing Allocation Based on Execution Efficiency Information

When, for example, information on processing fails to be provided before the processing is carried out, the processing is allocated based on another certain type of information while the processing is in execution. Here, a technique is illustrated in which the scheduler 23 executes processing allocation based on information on the execution efficiency.

The “execution efficiency” is any information that can express the execution efficiency of processing in a certain core. The first embodiment utilizes, for example, IPC (the number of instructions carried out per clock) as the execution efficiency. The execution efficiency is not limited to the IPC but various indicators may be utilized as the execution efficiency. For example, the information representing the execution efficiency may be an IPS (the number of instructions carried out per second), the number of execution clock cycles, power consumption, or performance per unit power consumption.

In the multi-core processor shown in FIG. 1, when no information on processing is statically provided, the scheduler 23 fails to determine whether the first core 100 or the second core 200 is to be allocated with the processing. In the first embodiment, an example is illustrated in which the processing is initially allocated to the core with MRAM as a local memory (in this case, the first core 100). The processing may be initially allocated to the core with SRAM as a local memory (in this case, the second core 200).

First, the scheduler 23 allocates the processing to the core ID1 of the core with MRAM as a local memory. The first core 100, which corresponds to the core ID1, starts carrying out the allocated processing.

The scheduler 23 starts acquiring execution information using a performance counter or the like when a trigger event is generated. When the next trigger event is generated, the scheduler 23 records the value of the IPC in an “IPC in ID1 core” item in the processing information table 21, shown in FIG. 8, based on information resulting from measurement using the performance counter or the like. Any trigger event may be used as long as the scheduler 23 can detect the trigger event. The trigger event may be, for example, the start/end of a process, the start/end of a thread, an interruption, or execution of a special instruction. The trigger event may be generated at every given number of cycles. Then, the scheduler 23 allocates the processing allocated to the core ID1 to the core ID2. The second core 200, which correspond to the core ID2, starts carrying out the processing. Acquisition of execution information is started using the performance counter or the like when a trigger event is generated. When the next trigger event is generated, the scheduler 23 records the value of the IPC in the second core 200 in an “IPC in ID2 core” item in the processing information table 21 based on information resulting from the measurement using the performance counter or the like.

When the next trigger event is generated, the scheduler 23 compares the magnitudes of the “IPC in the ID1 core” and the “IPC in the ID2 core”, both recorded in the processing information table 21, and shifts the processing to the core with the larger number. For example, for the processing ID 0x1 in FIG. 8, the “IPC in the ID1 core” is larger, and thus, the processing is shifted to the first core 100. For the processing ID 0x12 in FIG. 8, the “IPC in the ID2 core” is larger, and thus, the shift of the processing is omitted, with the processing continuously carried out in the second core 200.

(3) Allocation Based on Execution Efficiency Decrement Information

Another technique is illustrated in which dynamic processing allocation is carried out while processing is in execution as is the case with the processing allocation based on the IPC information described in “(2) processing allocation based on execution efficiency information”. In such an architecture as shown in FIG. 1, the processing management unit 20 may initially allocate processing to either the first core 100 (comprising MRAM as a local memory) or the second core 200 (comprising SRAM as a local memory). First, dynamic processing allocation will be described which is carried out when the processing is initially allocated to the first core 100 (MRAM core). Next, dynamic processing allocation will be described which is carried out when the processing is initially allocated to the second core 200 (SRAM core).

[Example of Initial MRAM Core Allocation]

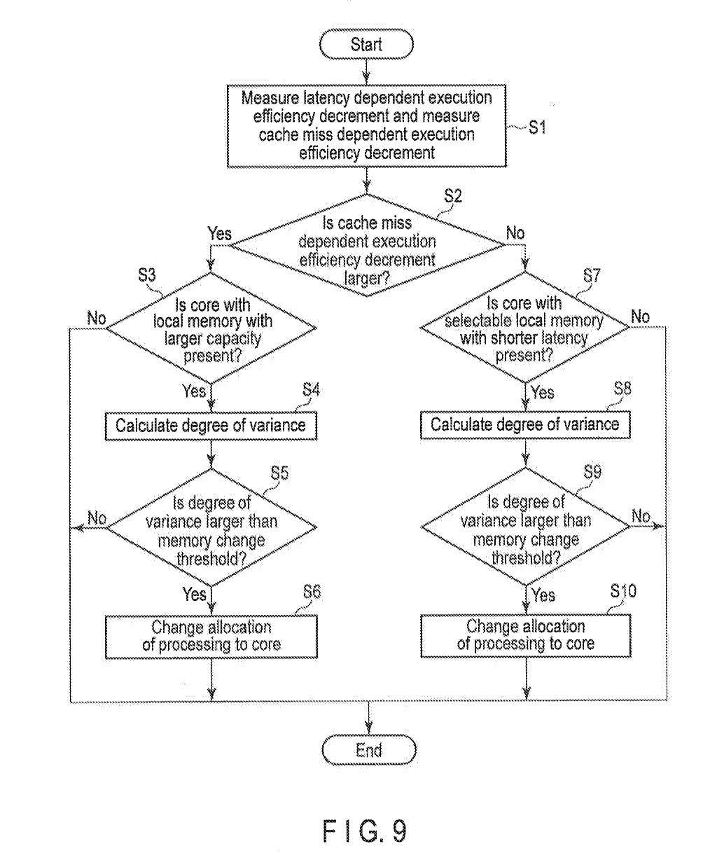

The dynamic processing allocation (scheduling) carried out when the processing is initially allocated to the first core 100 (the core with MRAM as a local memory) will be described with reference to a flowchart in FIG. 9.

First, the scheduler 23 allocates the processing to the first core 100 via the interface unit 24. The first core 100 executes the processing and performs measurement of a latency dependent execution efficiency decrement and measurement of a cache miss dependent execution efficiency decrement (step S1). The latency dependent execution efficiency decrement is the degree of a decrease in the execution efficiency of the core attributed to an amount of time from issuance of a request by the core until data requested by the core is transferred to the core when the data is present in a target memory. The cache miss dependent execution efficiency decrement is the degree of a decrease in the execution efficiency of the core attributed to an amount of time from issuance of the request by the core until the data requested by the core is transferred to the core when the data is not present in a target memory, that is, when a cache miss occurs.

In the first embodiment, the “target memory” is the L2 cache. Furthermore, the “execution efficiency decrement” is a numerical value representing the degree of a decrease in the execution efficiency of the core. The execution efficiency decrement may be, for example, the ratio of the duration of stalling of the core to the total execution duration, the duration of stalling of the core (for example, the actual duration or the number of clock cycles), or the rate of non-utilization of a calculator present in the core. The duration as used herein may be measured in units of time or in units of events in the core such as the number of clock cycles. The most direct technique for obtaining the above-described information is to measure the number of cycles in which the core stalls, using the performance counter or the like. However, when no performance counter with such a function is present, information from any other type of performance counter may be used for approximate calculations. The latency dependent execution efficiency decrement may be calculated, for example, based on the number of hits to the target memory per instruction. The cache miss dependent execution efficiency decrement may be calculated, for example, based on the number of cache misses per instruction.

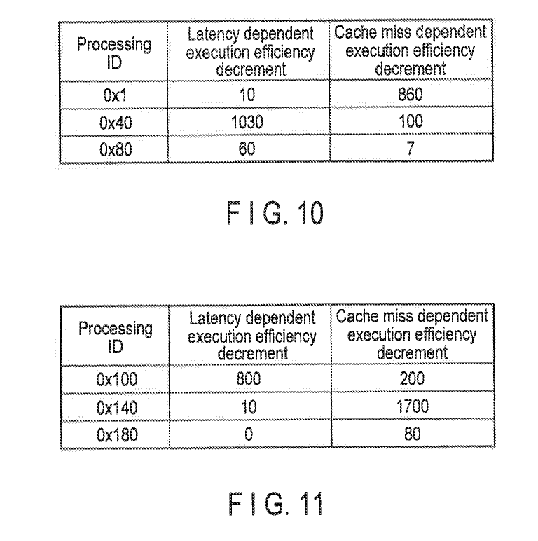

The information acquired using the above-described technique is obtained by the scheduler 23 from hardware via the interface unit 24. As shown in FIG. 10, the scheduler 23 records the latency dependent execution efficiency decrement and the cache miss dependent execution efficiency decrement in the processing information table 21 for each processing ID. These pieces of information are recorded as natural numbers according to the first embodiment. However, the information may be recorded in any form as long as the scheduler 23 can determine the magnitude of the recorded value. For example, the information may be recorded in the form of a decimal fraction or a character string. Furthermore, as described above, the latency dependent execution efficiency decrement and the cache miss dependent execution efficiency decrement are recorded in the processing information table 21. However, any other type of information may be recorded in the processing information table 21. For example, the IPC or the duration of execution of processing may be recorded in the processing information table 21.

When a trigger event is generated, the scheduler 23 determines which of the two execution efficiency decrements, the latency dependent execution efficiency decrement and the cache miss dependent execution efficiency decrement, is larger based on the information resulting from the measurement in step S1 (step S2). Any trigger event may be used as long as the scheduler 23 can detect the trigger event. The trigger event may be, for example, the start/end of a process, the start/end of a thread, an interruption, or execution of a special instruction. The trigger event may be an instruction provided every given time or an instruction of every given number of instructions. The trigger event may be generated at every given number of cycles. In the illustrated example, when a trigger event is generated, the latency dependent execution efficiency decrement and the cache miss dependent execution efficiency decrement are already recorded in the processing information table 21. However, the recording of the latency dependent execution efficiency decrement and the cache miss dependent execution efficiency decrement may be carried out simultaneously with a trigger event or appropriately before the trigger event. Furthermore, the magnitudes of the latency dependent execution efficiency decrement and the cache miss dependent execution efficiency decrement are compared when a trigger event is generated. However, the magnitudes may be recorded when both decrements are recorded in the processing information table 21. For example, when a policy is used in which the cache miss dependent execution efficiency decrement is subtracted from the latency dependent execution efficiency decrement, the scheduler 23 can determine that the cache miss dependent execution efficiency decrement is larger when the result is a negative number and determine that the latency dependent execution efficiency decrement is larger when the result is a positive number.

When the result of the magnitude determination in step S2 shows that the cache miss dependent execution efficiency decrement is larger as is the case with the processing ID 0x1 in FIG. 10, the scheduler 23 checks the core information table 22 to determine whether any core comprises a local memory having a larger capacity than the local memory of the core currently carrying out the processing (step S3). In this example, none of the cores other than the first core 100 comprises a local memory having a larger capacity than the local memory (MRAM) of the first core 100, Thus, the allocation of the processing to the core is not changed. When it is known that no option for a change in core allocation is present as in the present example, step S3 may be omitted.

On the other hand, when the result of the magnitude determination in step S2 shows that the latency dependent execution efficiency decrement is larger as is the case with a processing ID 0x40 in FIG. 10, the scheduler 23 checks the core information table 22 to determine whether any core comprises a local memory involving a shorter latency than the local memory of the core currently carrying out the processing (step S7). In this example, the second core 200 comprises a local memory (SRAM) involving a shorter latency, and thus, the scheduler 23 calculates the degree of variance (step S8). For example, the cache miss dependent execution efficiency decrement is subtracted from the latency dependent execution efficiency decrement to obtain a natural number of 930. The calculation of the degree of variance may be simultaneous with the magnitude determination in step S2. Any degree of variance may be used as long as the degree of variance represents the degree of the difference between the latency dependent execution efficiency decrement and the cache miss dependent execution efficiency decrement. The degree of variance may be the number of clock cycles, the actual duration, or a percentage of the duration of execution of processing. Then, the scheduler 23 compares the degree of variance calculated in step S8 with a core change threshold (according to the first embodiment, the core change threshold is 200) (step S9). When the degree of variance is higher than the core change threshold, the processing being carried out in the first core 100 is shifted to the second core 200 via the interface unit 24. That is, the core to which the processing is allocated is changed. A common means for shifting the processing is via migration carried out by the scheduler 23 in the OS. However, the means for shifting the processing between the cores is not particularly limited. For example, a processing shifting means implemented using hardware may be used. Furthermore, the migration may be carried out at any timing. The migration may be carried out simultaneously with a trigger event as in the above-described example or at a timing corresponding to a context switch generated by the OS. Any other timing may be used.

The core change threshold is a parameter for adjusting the easiness with which the processing is shifted between the cores. For example, the core change threshold may be a pre-provided parameter or may be calculated based on an overhead involved in the shift between the cores or the dominance ratio of the latency dependent execution efficiency decrement or the cache miss dependent execution efficiency decrement to the time interval between trigger events. For example, even when the result of the magnitude determination in step S2 shows that the latency dependent execution efficiency decrement is larger as is the case with a processing ID 0x00 in FIG. 10, the degree of variance is 53, which is smaller than the core change threshold of 200. Thus, the shift of the processing between the cores is omitted.

[Example of Initial SRAM Core Allocation]

Dynamic allocation carried out when the processing is initially allocated to the second core 200 (the core with SRAM as a local memory) will be described in accordance with a flowchart in FIG. 9. The definitions of terms and variations of design described below are similar to the definitions and variations in the above-described example of initial MRAM core allocation.

First, the scheduler 23 allocates the processing to the second core 200 via the interface unit 24. The second core 200 executes the processing and then performs measurement of the latency dependent execution efficiency decrement and measurement of the cache miss dependent execution efficiency decrement (step S1).

The scheduler 23 records the latency dependent execution efficiency decrement and the cache miss dependent execution efficiency decrement in the processing information table 21 for each ID that can identify processing, as shown in FIG. 11.

The scheduler 23 determines which of the two execution efficiency decrements, the latency dependent execution efficiency decrement and the cache miss dependent execution efficiency decrement, is larger based on the information resulting from the measurement in step S1 (step S2).

When the result of the magnitude determination in step S2 shows that the latency dependent execution efficiency decrement is larger as is the case with a processing ID 0x100 in FIG. 11, the scheduler 23 checks the core information table 22 to determine whether any core comprises a local memory involving a shorter latency than the local memory of the core currently carrying out the processing (step S3). In this example, none of the cores other than the second core 200 comprises a local memory having a shorter latency than the local memory (SRAM) of the second core 200. Thus, the allocation of the processing to the core is not changed. When it is known that no option for a change in core allocation is present as in the present example, step S3 may be omitted.

On the other hand, when the result of the magnitude determination in step S2 shows that the cache miss dependent execution efficiency decrement is larger, as is the case with a processing ID 0x140 in FIG. 11, the scheduler 23 checks the core information table 22 to determine whether any core comprises a local memory having a larger capacity than the local memory of the core currently carrying out the processing (step S3). In this case, the first core 100 comprises a local memory (MRAM) having a larger capacity, and thus, the scheduler 23 calculates the degree of variance (step S4). For example, the latency dependent execution efficiency decrement is subtracted from the cache miss dependent execution efficiency decrement to obtain a natural number of 1,690. The calculation of the degree of variance may be simultaneous with the magnitude determination in step S2. The scheduler 23 compares the degree of variance calculated in step S5 with a core change threshold (in the present example, the core change threshold is 200) (step S5). In this case, the degree of variance is larger than the core change threshold, and thus, the processing in execution in the second core 200 is shifted to the first core 100 via the interface unit 24 (step S6).

Even when the result of the magnitude determination in step 32 shows that the cache miss dependent execution efficiency decrement is larger as is the case with a processing ID 0x180 in FIG. 11, the degree of variance is 80, which is smaller than the core change threshold of 200. Thus, the allocation of the processing to the core is not changed.

The “(3) allocation based on execution efficiency decrement information” may be carried out in a simpler form. The above-described example uses the two pieces of execution efficiency information, the latency dependent execution efficiency decrement and the cache miss dependent execution efficiency decrement, and the thresholds. However, it is possible to perform control using only one of the two pieces of execution efficiency information and the threshold. An example is illustrated below.

For the “example of initial MRAM core allocation”, a scheme is possible in which, for example, only the latency dependent execution efficiency decrement is measured so that, when the measurement is equal to or larger than the threshold, the processing is reallocated to the SRAM core. This control is equivalent to the control scheme in FIG. 9 in which the cache miss dependent execution efficiency decrement is fixed to 0.

For the “example of initial SRAM core allocation”, a scheme is possible in which, for example, only the cache miss dependent execution efficiency decrement is measured so that, when the measurement is equal to or larger than the threshold, the processing is reallocated to the MRAM core. This control is equivalent to the control scheme in FIG. 9 in which the latency dependent execution efficiency decrement is fixed to 0.

When such control is performed, each of the processing information tables in FIG. 10 and FIG. 11 may be a table in which either one of the two execution efficiency decrements, the latency dependent execution efficiency decrement and the cache miss dependent execution efficiency decrement, is recorded.

(4) Processing Allocation Based on Combination

Scheduling based on a combination of (1) to (3) described above may be carried out on the multi-core processor in FIG. 1. The scheduling will be described below in brief.

(General procedure 1) The scheduling in (3) is carried out, and when the allocation of the processing to the core need not be changed, the local memory of the core carrying out the processing is recorded in the processing information table 21 as a processing attribute. The procedure then proceeds to (General procedure 3) described below. When the allocation of the processing to the core is changed, the procedure proceeds to (General procedure 2).

(General procedure 2) The IPCs of the cores are measured before and after a change in allocation. Based on the results of measurement of the IPCs, the scheduling in (2) is carried out to identify the optimum core. The local memory of the identified optimum core is recorded in the processing information table 21 as a processing attribute.

(General procedure 3) For the second and subsequent executions of the processing, when a processing attribute has been recorded, the scheduling in (1) is carried out based on the processing attribute information.

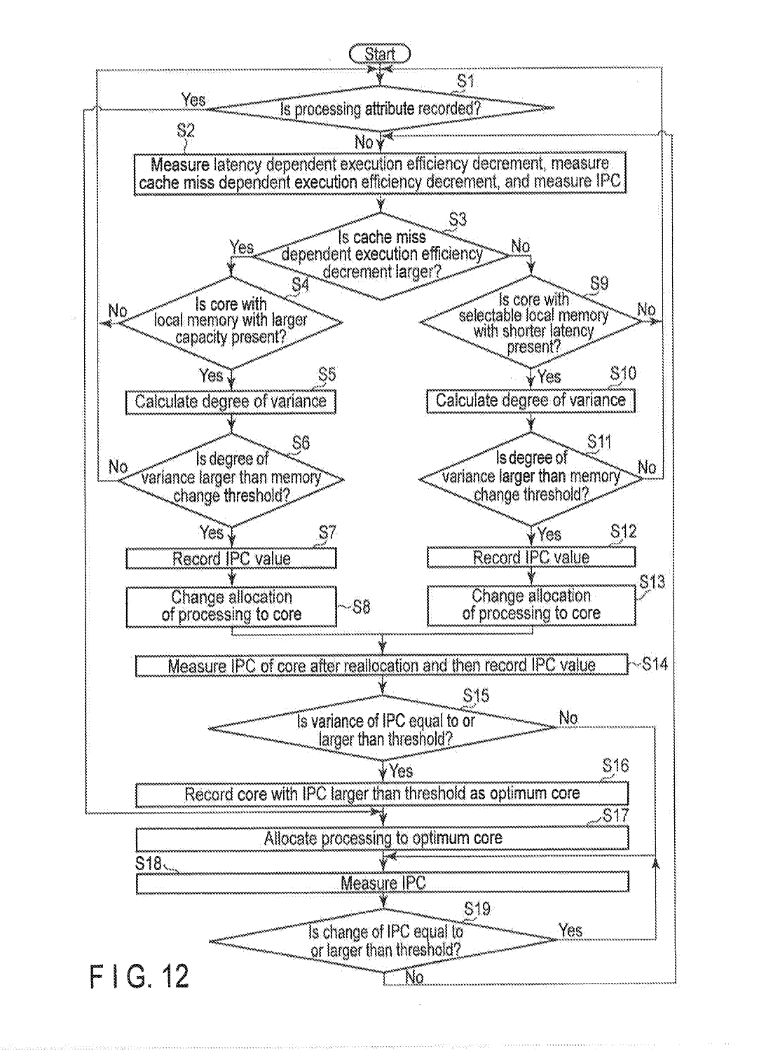

The details of an algorithm for the scheduling are shown in a flowchart in FIG. 12. For simplification of description, the description focuses on step S14 carried out immediately after the end of the processing described in the example in (3) and the steps subsequent to step S14. In this case, by way of example, a policy is used in which the processing is initially allocated to the first core 100 with MRAM as a local memory.

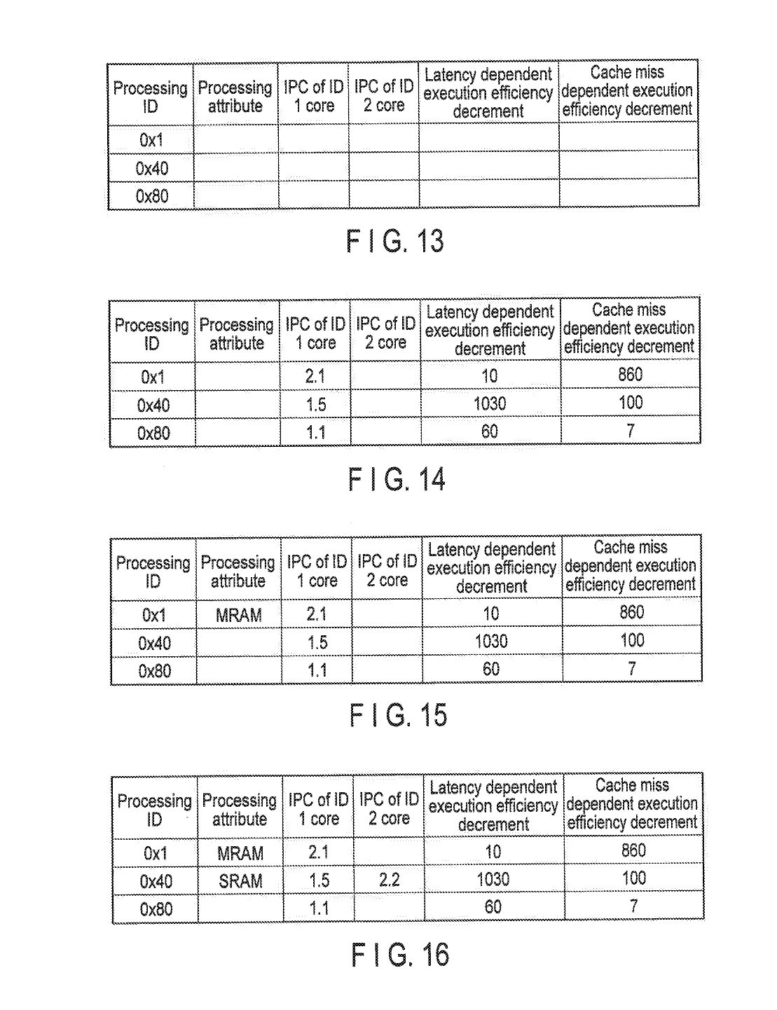

The processing information table 21 used in the present example is shown in FIG. 13. As shown in FIG. 13, the processing information table 21 used in the present example has the following items for each processing ID the processing attribute used for the scheduling in (1), the IPCs in the ID1 core and the ID2 core used for the scheduling in (2), and the latency dependent execution efficiency decrement and cache miss dependent execution efficiency decrement used for the scheduling in (3).

Upon starting carrying out the processing, the scheduler 23 checks the processing attribute item in the processing information table 21 in FIG. 13 (step S1). At this point in time, no information is recorded in the processing attribute item, and thus, the scheduler 23 allocates the processing to the first core 100. FIG. 14 shows a state in which a trigger event is generated. The scheduler 23 records, in the processing information table 21, the IPC in the first core 100 during execution, which is used for the scheduling in (2), in addition to the latency dependent execution efficiency decrement and the cache miss dependent execution efficiency decrement, which are used for the scheduling in (3) (step S2).

As illustrated in the example in (3), for the processing 0x1, the core allocation need not be changed, and thus, the shift of the processing is omitted, with the first core 100 continuously carrying out the processing. In this case, “MRAM”, which is indicative of information on the local memory for the first core 100, is recorded in the processing attribute item. Similarly, for the processing 0x80, the core allocation need not be changed. However, the latency dependent execution efficiency decrement is not very large compared to the cache miss dependent execution efficiency decrement, and the processing fails to be determined to be suitable for the first core 100. Thus, no information is recorded in the processing attribute item. The core allocation needs to be changed for the processing 0x40. Thus, the core allocation is changed with no information recorded in the processing attribute item. FIG. 15 shows the processing information table 21 on which the above-described procedure has been completely carried out. The above-described control may take a simpler form as is the case with the “(3) allocation based on execution efficiency decrement”. For example, it is possible to determine whether the core allocation is to be changed using only the latency dependent execution efficiency decrement and the threshold.

For the processing 0x40, the second core 200 starts carrying out the processing after the core allocation is changed. Upon detecting a trigger event, the scheduler 23 measures the IPC of the processing 0x40 during execution in the second core 200, and records the IPC in the processing information table 21 (step S14).

The IPC in the second core 200 is assumed to be 2.2. At the same time, the scheduler 23 compares the magnitudes of the IPC in the ID1 core, 1.5, and the IPC in the ID2 core, 2.2 (step S15). In this example, the IPC in the ID2 core is larger than the IPC in the ID1 core, and thus, the scheduler 23 determines that the core allocation need not be changed. The scheduler 23 records SRAM, which is information indicative of the local memory for the second core 200, as a processing attribute for the processing ID 0x40. FIG. 16 shows the processing information table 21 on which the above-described procedure has been completely carried out. On the other hand, when the result of the determination in step S15 shows that the variance of the IPC is equal to or larger than the threshold, the scheduler 23 records the core with an IPC larger than the threshold as the optimum core and allocates the processing to the optimum core (steps S15 and S16).

When the processing with the processing ID 0x1 or the processing with the processing ID 0x40 is carried out again, the scheduling in (1) may be used. The scheduler 23 checks the processing attribute item in the processing information table 21 in FIG. 16 (step S1) and allocates the processing 0x1 and the processing 0x40 to the first core 100 and the second core 200, respectively (step S16). This technique allows the processing to be appropriately allocated to the cores.

After determining the appropriate core using the above-described technique, the scheduler 23 may measure the IPC in the core carrying out the processing each time a trigger event is generated (step S17). The scheduler 23 compares the IPC measured at the time of the last trigger event and the IPC measured at the time of the current trigger event, both of which are recorded in the processing information table 21 (step S18). When the change of the IPC is equal to or larger than the IPC threshold, the scheduler 23 determines that the characteristics of the processing have changed. The scheduler 23 then executes scheduling to select the appropriate core again (the scheduling is carried out in the following order: (3)→(2)→(1)). During the measurement of the IPC, the latency dependent execution efficiency decrement and the cache miss dependent execution efficiency decrement may be continuously measured in preparation for a change in the characteristics of the processing, or the measurement may be resumed after a change in the characteristics of the processing is detected.

The allocation of the processing to the core need not necessarily be carried out strictly in accordance with the policies of the scheduling in (1) to (4) described above. For example, in the core to which the processing is to be allocated in accordance with the scheduling in (1) to (4), another type of processing may be in execution. In such a case, in view of factors such as load balancing, the processing may be allocated to a core other than the core determined in accordance with the scheduling in (1) to (4), or the allocation of the processing to the core may be postponed or halted. Such scheduling may be implemented by combining the scheduling in (1) to (4) with a scheduling technique intended for load balancing.

### Second Embodiment

In the example illustrated in the first embodiment, the heterogeneous memory configuration is applied to the L2 cache. In an example illustrated in a second embodiment, the heterogeneous memory configuration is applied to the L1 cache.

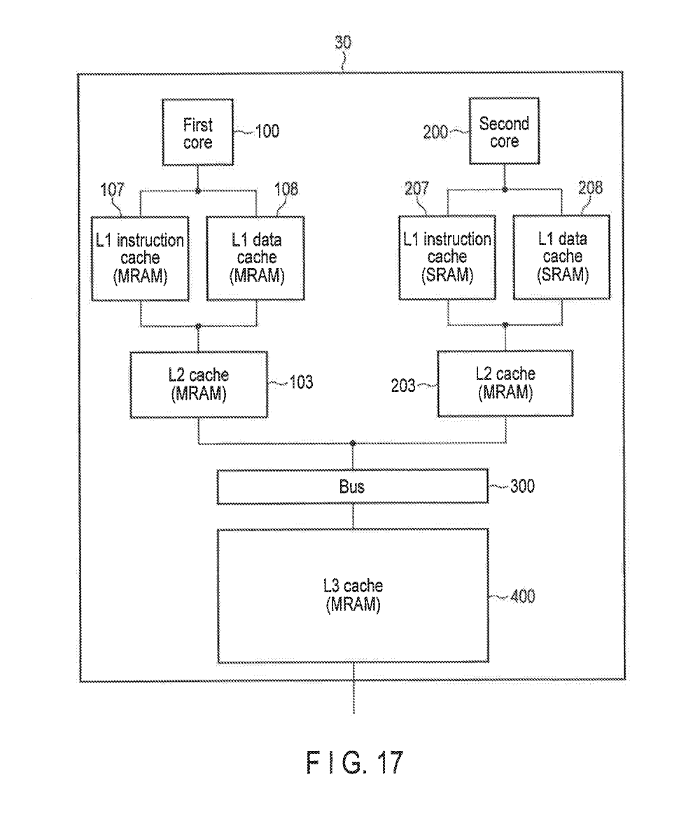

FIG. 17 shows a multi-core processor according to the second embodiment. MRAM is utilized as each of L2 caches 103 and 203 and as an L3 cache 400, but any memory may be utilized as each of the caches. For example, each of the L2 caches 103 and 203 may be DRAM or SRAM, and the L3 cache 400 may he DRAM or SRAM.

In the second embodiment, MRAM is utilized as each of L1 caches 107 and 108 for a first core 100 provided in a die 30, and SRAM is utilized as each of L1 caches 207 and 208 for a second core 200 provided in the die 30. For the first core 100, a path from the first core 100 to the L3 cache 400 is MRAM (L1 caches 107 and 108)→MRAM (L2 cache 103)→MRAM (L3 cache 400). For the second core 200, a path from the second core 200 to the L3 cache 400 is SRAM (L1 caches 207 and 208)→MRAM (L2 cache 203)→MRAM (L3 cache 400). Thus, the first core 100 and the second core 200 have memory configurations with different unit cell configurations.

As illustrated in FIG. 17 showing the second embodiment, each of the L1 caches 107 and 108 for the first core 100 is wholly configured using MRAM, and each of the L1 caches 207 and 208 for the second core 200 is wholly configured using SRAM. However, the first core 100 and the second core 200 need not necessarily be configured in such a manner. In other words, memories with different unit cell configurations may be used as parts of the memories providing the L1 caches for each of the first and second cores 100 and 200. For example, MRAM may be utilized as the L1 instruction cache 107 for the first core 100, SRAM may be utilized as the L1 data cache 108 for the first core 100, and SRAM may be utilized as both of the L1 caches 207 and 208 for the second core 200. Alternatively, SRAM may be utilized as the L1 instruction cache 107 for the first core 100, MRAM may be utilized as the L1 data cache 108 for the first core 100, and SRAM may be utilized as both of the L1 caches 207 and 208 for the second core 200.

A hardware control method for the multi-core processor according to the present embodiment may be similar to the hardware control method according to the first embodiment. Furthermore, for a software control method, the scheduling in (1) to (4) may be utilized as is the case with the first embodiment. However, the software control method is not limited to these schemes.

### Third Embodiment

In the first embodiment and the second embodiment, the multi-core processor with the uniform cores is illustrated. In a third embodiment, a multi-core processor with nonuniform cores is illustrated.

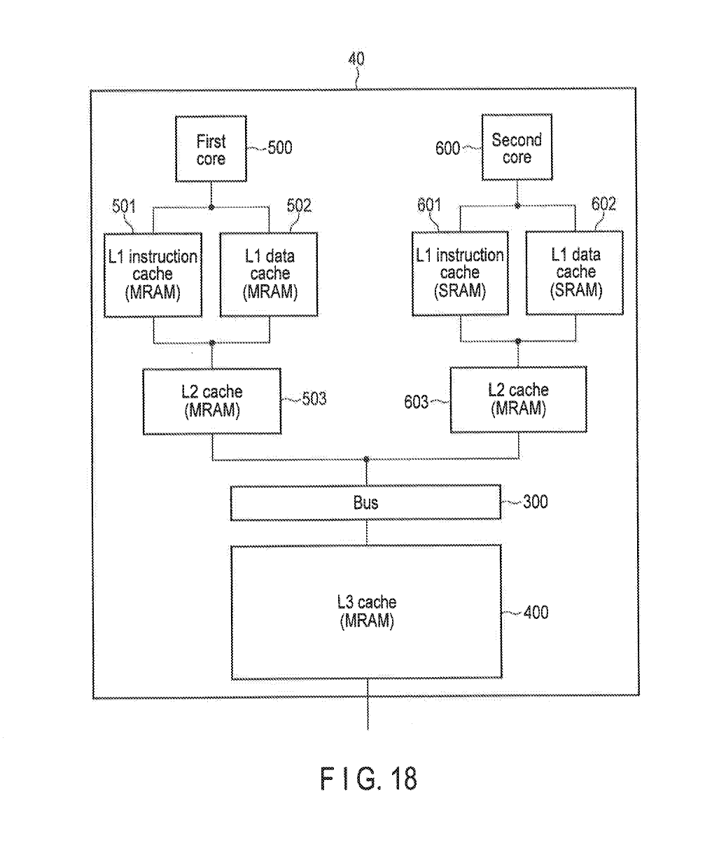

FIG. 18 shows a multi-core processor according to the third embodiment. A first core 500 provided in a die 40 and a second core 600 provided in the same die 40 comprise the same instruction set but exhibit different levels of performance. The performance of the core refers to quantitative values indicative of the characteristics of the core. The performance of the core is, for example, a program execution speed and power consumption per unit time. In a more specific example, the performance of the core may be determined based on the number of calculators in the core, memory size, or the like. In the present embodiment, the performance of the core is, for example, the operating frequency of the core. Furthermore, the operating frequency of the first core 500 is lower than the operating frequency of the second core 600.

As shown in FIG. 18, MRAM is utilized as each of L2 caches 503 and 603 and as an L3 cache 400. However, any memory may be utilized as each of the caches. For example, each of the L2 caches 503 and 603 may be DRAM or SRAM, and the L3 cache 400 may be DRAM or SRAM. Furthermore, MRAM is utilized as each of L1 caches 501 and 502 for the first core 500, and SRAM is utilized as each of L1 caches 601 and 602 for the second core 600.

For the first core 500, a path from the first core 500 to the L3 cache 400 is MRAM (L1 caches 501 and 502)→MRAM (L2 cache 503)→MRAM (L3 cache 400). In contrast, for the second core, a path from the second core to the L3 cache 400 is SRAM (L1 caches 601 and 602)→MRAM (L2 cache 603)→MRAM (L3 cache 400), Thus, the first core 500 and the second core 600 have memory configurations with different unit cell configurations.

As illustrated in FIG. 18 showing the third embodiment, each of the L1 caches 501 and 502 for the first core 500 is wholly configured using MRAM, and each of the L1 caches 601 and 602 for the second core 600 is wholly configured using SRAM. However, the first core 500 and the second core 600 need not necessarily be configured in such a manner. In other words, memories with different unit cell configurations may be used as parts of the memories providing the L1 caches for each of the first and second cores 500 and 600. For example, MRAM may be utilized as the L1 instruction cache 501 for the first core 500, SRAM may be utilized as the L1 data cache 502 for the first core 500, and SRAM may be utilized as both of the L1 caches 601 and 602 for the second core 600. Alternatively, SRAM may be utilized as the L1 instruction cache 501 for the first core 500, MRAM may be utilized as the L1 data cache 502 for the first core 500, and SRAM may be utilized as both of the L1 caches 601 and 602 for the second core 600.

A hardware control method for the multi-core processor according to the present embodiment may be similar to the hardware control method according to the first embodiment. Furthermore, for a software control method, the scheduling in (1) to (4) may be utilized as is the case with the first embodiment, However, the software control method is not limited to these schemes.

### Fourth Embodiment

According to the first to third embodiments, it is assumed that all the cores comprise the same instruction set. A fourth embodiment relates to a multi-core processor comprising a plurality of cores mounted therein and having different instruction sets.

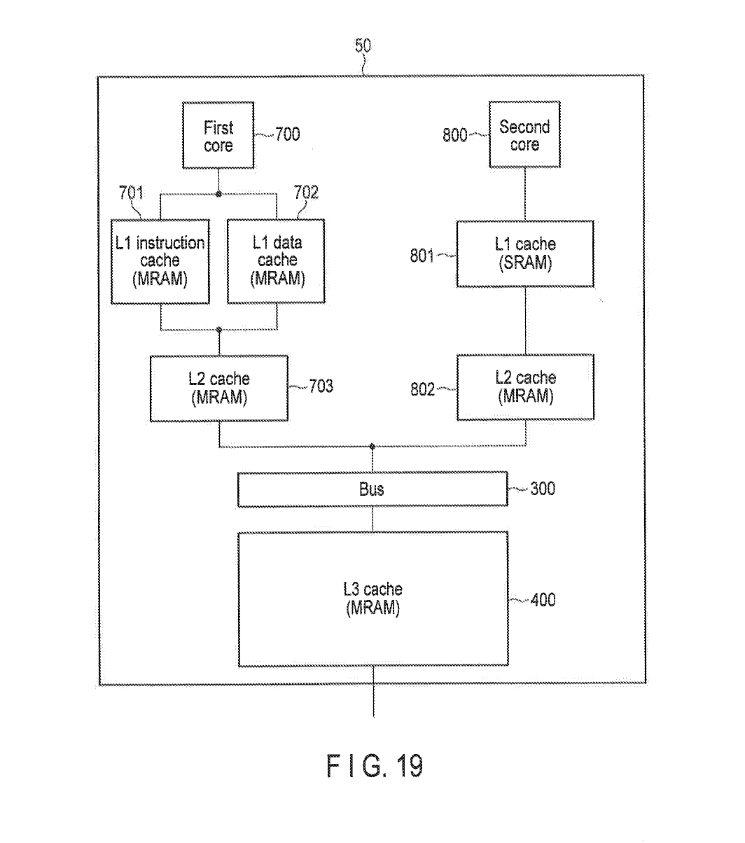

FIG. 19 shows an example of the multi-core processor according to the fourth embodiment. A first core 700 provided in a die 50 is, for example, a general-purpose CPU. A second core 800 provided in the same die 50 is, for example, a GPU for image processing.

In a configuration shown in FIG. 19, MRAM is utilized as each L2 caches 703 and 802 and as an L3 cache 400, However, any memory may be utilized as each of the caches. For example, each of the L2 caches 703 and 802 may be DRAM or SRAM, and the L3 cache 400 may be DRAM or SRAM. Furthermore, MRAM is utilized as each of L1 caches 701 and 702 for the first core 700, and SRAM is utilized as an L1 cache 801 for the second core 800.

For the first core 700, a path from the first core 700 to the L3 cache 400 is MRAM (L1 caches 701 and 702)→MRAM (L2 cache 703)→MRAM (L3 cache 400). On the other hand, for the second core 800, a path from the second core 800 to the L3 cache 400 is SRAM (L1 caches 801)→MRAM (L2 cache 802)→MRAM (L3 cache 400). Thus, the first core 700 and the second core 800 have memory configurations with different unit cell configurations.

As illustrated in FIG. 19 showing the fourth embodiment, each of the L1 caches 701 and 702 for the first core 700 is wholly configured using MRAM, and the L1 cache 801 for the second core 800 is wholly configured using SRAM. However, the first core 700 and the second core 800 need not necessarily be configured in such a manner.

In other words, “memories with different unit cell configurations” may be used as parts of the memories providing the L1 caches 701 and 702 and 801 for the first and second cores 700 and 800. For example, MRAM may be utilized as the L1 instruction cache 701 for the first core 700, SRAM may be utilized as the L1 data cache 702 for the first core 700, and SRAM may be utilized as the L1 cache 801 for the second core 800. Alternatively, SRAM may be utilized as the L1 instruction cache 701 for the first core 700, MRAM may be utilized as the L1 data cache 702 for the first core 700, and SRAM may be utilized as the L1 cache 801 for the second core.

A hardware control method for the multicore processor according to the present embodiment may be similar to the hardware control method according to the first embodiment. Furthermore, for a software control method, the scheduling in (1) to (4) may be utilized, as in the case with the first embodiment. However, the software control method is not limited to these schemes.

A hybrid cache configuration of the multi-core processor has been described in which non-volatile memories are utilized as local caches for some cores, whereas volatile memories are utilized as local caches for the remaining cores. In a typical example, a multi-core processor is configured such that non-volatile memories such as MRAM are utilized as local memories for a large number of cores, whereas volatile memories such as SRAM are utilized as local memories for some remaining cores. Moreover, as described above, the scheduler, which allocates processing to the cores, selects a memory (local cache) suitable for each type of processing through the allocation of the processing to the cores.

Therefore, the above-described hybrid cache configuration enables the software to select the appropriate memory according to the characteristics of the program. Thus, the processing efficiency of the processor can be improved with a possible increase in hardware design costs and in circuit area suppressed.

While certain embodiments have been described, these embodiments have been presented by way of example only, and are not intended to limit the scope of the inventions.

Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A multi-core processor which is capable of executing a plurality of tasks, the multi-core processor comprising at least a first core and a second core,
wherein the first core and the second core are capable of accessing a shared memory area,
the first core comprises one or more memory layers in an access path to the shared memory area, the one or more memory layers comprising a local memory for the first core,
the second core comprises one or more memory layers in an access path to the shared memory area, the one or more memory layers comprising a local memory for the second core, and
the local memory for the first core and the local memory for the second core comprise memories with different unit cell configurations in at least one identical memory layer.

2. The multi-core processor according to claim 1, wherein the first core and the second core comprise an identical instruction set.

3. The multi-core processor according to claim 1, wherein the first core and the second core comprise different instruction sets.

4. The multi-core processor according to claim 2, wherein a first execution efficiency obtained when a program is executed by the first core is identical to a second execution efficiency obtained when the program is executed by the second core.

5. The multi-core processor according to claim 2, wherein a first execution efficiency obtained when a program is executed by the first core is different from a second execution efficiency obtained when the program is executed by the second core.

6. The multi-core processor according to claim 1, wherein, in the at least one identical layer, the local memory for the first core comprises a non-volatile memory, and the local memory for the second core comprises a volatile memory.

7. The multi-core processor according to claim 1, wherein, in the at least one identical layer, the local memory for the first core comprises a first non-volatile memory, and the local memory for the second core comprises a second non-volatile memory, and
the first non-volatile memory and the second non-volatile memory comprise respective logical circuits with different characteristics.

8. The multi-core processor according to claim 6,
wherein the non-volatile memory is MRAM (Magnetic Random-Access Memory), and
the volatile memory is SRAM (Static RAM).

9. A multi-core processor which is capable of executing a plurality of tasks, the multi-core processor comprising at least a first core, a second core, and a scheduler which allocates processing to one of the first and second cores,
wherein the first core and the second core are capable of accessing a shared memory area,
the first core comprises one or more memory layers in an access path to the shared memory area, the one or more memory layers comprising a local memory for the first core,
the second core comprises one or more memory layers in an access path to the shared memory area, the one or more memory layers comprising a local memory for the second core, and
the local memory for the first core and the local memory for the second core comprise memories with different unit cell configurations in at least one identical memory layer.

10. A control method for the multi-core processor according to claim 9, comprising
allocating, by the scheduler, processing to one of the first and second cores; and
enabling, by the scheduler, the processing to be reallocated to the other of the first and second cores based on an execution efficiency of the processing,

11. A control method for the multi-core processor according to claim 9, comprising:
allowing, by the scheduler, each of the first and second cores to execute processing;
measuring, by the scheduler, a first indicator indicative of execution efficiency of the processing in the first core and a second indicator indicative of execution efficiency of the processing in the second core; and
allocating, by the scheduler, the processing to one of the first and second cores based on a result of comparison of the first indicator with the second indicator.

12. The method according to claim 10, further comprising:
measuring, by the scheduler, at least one of two decrements, a first decrement in the execution efficiency of the processing attributed to latency and a second decrement in the execution efficiency of the processing attributed to storage capacity; and
changing, by the scheduler, allocation of the processing according to a result of comparison of the first decrement with a threshold for reallocation of the processing or a result of comparison of the second decrement with a threshold for reallocation of the processing or when an absolute value of a difference between the first decrement and the second decrement exceeds a threshold for reallocation of the processing.
